(19) United States
(12) Patent Application Publication
(10) Pub. No.: US 2024/0304431 A1
(43) Pub. Date: Sep. 12, 2024

(54) IMPEDANCE-MATCHED COAXIAL CONDUCTOR, ELECTRICALLY CONDUCTING CONTACTING ELEMENT AND COMPACT TIME-OF-FLIGHT MASS ANALYZER

(71) Applicant: SPACETEK TECHNOLOGY AG, Gümligen (CH)

(72) Inventors: Jürg JOST, Gümligen (CH); Lukas HOFER, Meilen (CH)

(21) Appl. No.: 18/264,335

(22) PCT Filed: Jan. 6, 2022
(86) PCT No.: PCT/IB2022/050087

§ 371 Date: Aug. 4, 2023

(30) Foreign Application Priority Data
Feb. 5, 2021 (EP) 21155560.2

(51) Int. Cl. H01J 49/04; H01J 49/40

(52) U.S. Cl. CPC H01J 49/0409; H01J 49/40

(57) ABSTRACT

An impedance-matched coaxial conductor for a vacuum environment, comprising an electrically conducting inner conductor, an electrically conducting outer hollow conductor configured to surround the inner conductor substantially along its entire length, whereby the outer hollow conductor is separated from the inner conductor, at least an electrically isolating element positioned between the inner conductor and the outer hollow conductor in order to maintain the separation between them, a space between the inner conductor and the outer hollow conductor being vacuum pumpable. An electrically conducting contacting element for a vacuum environment, which is configured to establish an electrical contact between a first conductor and a second conductor, comprising a body made from an electrically conducting material; at least a through hole in the body, configured to accept inside the hole the first conductor in form of an elongated electrical conductor; at least a first threaded hole in the body, oriented substantially perpendicular to the through hole, and extending from an outside surface of the body to the through hole, the threaded hole being configured to accept a screw; and at least a second threaded hole in the body. A time-of-flight mass analyzer comprising a plurality of functional parts selected from at least the following list: an ion source, an extraction region, a drift region, a reflectron, and a detector; a single vacuum flange configured to connect on a vacuum chamber; a plurality of platforms; at least one pillar for each of the plurality of platforms, configured for fixing and distancing the corresponding platform either to the single vacuum flange or to a neighboring platform from the plurality of platforms; each of the plurality of platforms being configured to gather a subset of the plurality of functional parts to obtain a subassembly; and the subassemblies and the single vacuum flange being arranged to form a longish elongated assembly in which each of the platforms defines a mechanical reference in the longish elongated assembly.

### TECHNICAL FIELD

This invention relates to a compact time-of-flight mass analyzer for a mass spectrometer for the determination of the chemical composition of liquid or gases.

### BACKGROUND

In many domains of industrial application there is the need to measure the chemical composition of a substance, in the form of a liquid or gas, with a compact device that can be integrated inline of production equipment or infrastructure. For example, coating processes used in the manufacturing of semiconductors, optics, and displays need accurate process control, which can be achieved by measuring at high rate, such as every fraction of a second, the composition of the gas that is delivered to the substrate in a vacuum deposition process. Mass spectrometers are high-performance instruments that are typically used in a laboratory to determine the chemical composition of a gas or liquid. A mass spectrometer is “an instrument in which beams of ions are separated according to the quotient mass/charge” [1]. A mass spectrometer works by directly measuring the positive or negative ions of atoms or molecules of a substance created inside the instrument ion source. These ions are then delivered to a mass analyzer that obtains a mass spectrum, where each atomic or molecular species can be identified by their characteristic spectrum represented on a calibrated scale of mass-to-charge ratio vs intensity.

A mass spectrometer can be used to monitor the chemical composition of a substance at regular time intervals, and therefore can be used as a sensor for process control. Mass spectrometers exist both as instruments that need to be operated by a human operator in the lab and as autonomous devices instruments that can automatically analyze a substance at defined time intervals and provide the results of this analysis to a computer system over a network. Examples of such devices include orifice inlet mass spectrometers, which use a small pinhole to transfer a gas sample in vacuum, and membrane inlet mass spectrometers, which use a membrane that is semi-permeable to the gas or liquid sample being analyzed. There are different methods to separate ions by their mass-to-charge ratio. One method is to use a quadrupole filter that allows only ions with a certain mass-to-charge ratio to pass through it and hit a detector. By scanning a certain range of mass, a quadrupole mass spectrometer can generate a mass spectrum. These instruments can be very sensitive, but they are slow, because of the need to perform a scan of the mass spectrum which makes them able to produce a spectrum every, for example, 10 s or longer. In addition, to achieve high sensitivity in the measurement of samples that contains substances present in very low or trace amounts, which requires a capability to measure high as well as low signal, quadrupole mass spectrometers need to use gain switching, which is very challenging to implement in the electronics while ensuring that the instrument's measurement remains quantitative. Moreover, their manufacturing is challenging, as the bars of the quadrupole need precise mechanical alignment at the level of few micrometers to achieve the desired performance.

Another method to separate ions by their mass-to-charge ratio is to accelerate a group of ions from a sample with substantially the same kinetic energy into an ion-optical system that directs them towards a detector. Because all the ions start with substantially the same kinetic energy, but have different masses, their time of arrival at the detector will depend on their mass to charge ratio. Therefore, by measuring the time of arrival of the ions at the detector, using very-fast electronics, one can obtain a mass spectrum, hence the name of time-of-flight mass analyzers or spectrometers for this kind of devices. These instruments are very sensitive and fast, because they usually work at kHz repetition rate, meaning that they acquire thousands of spectra every second, which are then summed up inside the instrument electronics to produce a spectrum every, for example, 0.1 or 1s, that is about ten or hundred times faster than a typical quadrupole mass spectrometer. Moreover, the whole spectrum in a time-of-flight mass spectrometer is acquired with the same gain setting of the detector, thus allowing for fast yet quantitative and sensitive measurements. These instruments, however, require high-performance electronics, in particular when the instrument is compact and the time of flight of the ions in the mass analyzer is short, in the order of few microseconds. Moreover, their performance is very sensitive to details of the design of the ion optics of the mass analyzer. As a consequence, time-of-flight mass spectrometers are usually large and expensive instruments that are only found in high-end laboratories, but that are not used online of industrial manufacturing equipment for process control, whereby a compact size is important to allow for their integration inline of industrial manufacturing equipment. One the other hand, quadrupole mass spectrometers, despite their disadvantages, can be built small and hence are commonly used as process control instruments in industry.

The present invention aims at addressing the above-described inconveniences. Thereby it enables the use of fast time-of-flight mass analyzers in fields of industry where previously only quadrupole mass spectrometers were used, thus opening new possibilities for faster and more sensitive process and product quality control in various domains of industrial application

### SUMMARY OF THE INVENTION

In a first aspect, the invention provides an impedance-matched coaxial conductor for a vacuum environment, comprising an electrically conducting inner conductor, an electrically conducting outer hollow conductor configured to surround the inner conductor substantially along its entire length, whereby the outer hollow conductor is separated from the inner conductor, at least an electrically isolating element positioned between the inner conductor and the outer hollow conductor in order to maintain the separation between them, a space between the inner conductor and the outer hollow conductor being vacuum pumpable.

In a preferred embodiment, the outer hollow conductor comprises on one extremity of the impedance-matched coaxial conductor a means for connecting to a coaxial feedthrough of a wall of a vacuum chamber.

In a further preferred embodiment, the outer hollow conductor comprises on the one extremity an internal cylindrical surface and a screwable thread on the internal surface, configured to screw in the coaxial feedthrough.

In a second aspect, the invention provides an electrically conducting contacting element for a vacuum environment, which is configured to establish an electrical contact between a first conductor and a second conductor. The contacting element comprises a body made from an electrically conducting material; at least a through hole in the body, configured to accept inside the hole the first conductor in form of an elongated electrical conductor; at least a first threaded hole in the body, oriented substantially perpendicular to the through hole, and extending from an outside surface of the body to the through hole, the threaded hole being configured to accept a screw; and at least a second threaded hole in the body.

In a further preferred embodiment, the electrical conducting material is made from stainless steel.

In a third aspect, the invention provides a method for vacuum-proof electrical contacting, comprising providing an electrically conducting contacting element for a vacuum environment, which Is configured to establish an electrical contact between a first conductor and a second conductor. The contacting element comprises a body made from an electrically conducting material; at least a through hole in the body, configured to accept inside the hole the first conductor in form of an elongated electrical conductor; at least a first threaded hole in the body, oriented substantially perpendicular to the through hole, and extending from an outside surface of the body to the through hole, the threaded hole being configured to accept a first screw; and at least a second threaded hole in the body.

The method further comprises clamping the first conductor inside the through hole by means of the first screw screwed inside the first threaded hole and protruding in the through hole; and mounting the electrically conducting contacting element on the second conductor by means of a second screw screwed in the second threaded hole.

In a further preferred embodiment, the method further comprises providing the second conductor as a track on a surface of a printed circuit board; and passing the second screw through an aperture in the printed circuit board before screwing it in the second threaded hole.

In a further preferred embodiment, the method further comprises providing the second conductor as a further elongated electrical conductor; and clamping the further elongated electrical conductor onto the electrically conducting contacting element by means of the second screw screwed into the second threaded hole.

In a fourth aspect the invention provides a time-of-flight mass analyzer comprising a plurality of functional parts selected from at least the following list: an ion source, an extraction region, a drift region, a reflectron, and a detector; a single vacuum flange configured to connect on a vacuum chamber; a plurality of platforms; at least one pillar for each of the plurality of platforms, configured for fixing and distancing the corresponding platform either to the single vacuum flange or to a neighboring platform from the plurality of platforms; each of the plurality of platforms being configured to gather a subset of the plurality of functional parts to obtain a subassembly; and the subassemblies and the single vacuum flange being arranged to form a longish elongated assembly in which each of the platforms defines a mechanical reference in the longish elongated assembly.

In a further preferred embodiment, the platforms are stacked on top of each other onto the single vacuum flange.

In a further preferred embodiment, the time-of-flight mass analyzer further comprises at least an additional platform, and at least one additional pillar for each of the additional platforms, whereby each of the additional platforms is mounted directly on the single vacuum flange by means of the one of plurality of corresponding additional pillars.

In a further preferred embodiment, at least one of the plurality of platforms and the additional platforms is defined as a first level platform. The time-of-flight mass analyzer further comprises for each first level platform at least one second level platform mounted on the first level platform by means of at least a corresponding second level pillar.

In a further preferred embodiment, the single vacuum flange comprises an opening. The time-of-flight mass analyzer further comprises an annex vacuum chamber mounted on the opening of the single vacuum flange; and at least a further annex platform located inside the annex vacuum chamber.

In a further preferred embodiment, the time-of-flight mass analyzer further comprises a particle shield located on the single vacuum flange on a side oriented toward the at least one platform and configured to protect an inside of the annex vacuum chamber from charged particles.

In a further preferred embodiment, the time-of-flight mass analyzer further comprises at least a screw system configured to fix a least one of the plurality of platforms to the corresponding at least one pillar.

### BRIEF DESCRIPTION OF THE DRAWINGS

The invention will be better understood through the detailed description of preferred embodiments, and in reference to the drawings, wherein

FIG. 1a illustrates schematically a mechanical design of a time-of-flight mass spectrometer mounted on the vacuum side of a single vacuum flange;

FIG. 1b illustrates schematically a mechanical design of a time-of-flight mass spectrometer mounted on the vacuum side of a single vacuum flange, wherein a plurality of second levels platforms are mounted onto a first level platform;

FIG. 1c illustrates schematically a mechanical design of a time-of-flight mass spectrometer mounted on the vacuum side of a single vacuum flange, wherein platforms are mounted on their respective own pillar(s);

FIG. 1d illustrates schematically an embodiment of mechanical design of a time-of-flight spectrometer mounted on the vacuum side of a single vacuum flange, in which a vacuum chamber is installed in an opening of the single vacuum flange;

FIG. 1e illustrates a similar mechanical design as shown in FIG. 1d, without an optional detector shield, according to an example of the invention;

FIG. 2 schematically illustrates an impedance-matched coaxial conductor for vacuum environment according to an example of the invention;

FIG. 3a schematically illustrates a vacuum-proof electrical contacting element according to an example of the invention;

FIG. 3b illustrates the contacting element from FIG. 3a in an example use;

FIG. 3bb illustrate a further example of the contacting element;

FIG. 3c illustrates the contacting element from FIG. 3b in a further example use; and

FIGS. 3d, 3e and 3f illustrate further examples of the contacting element.

Same references will be used to refer to same of similar features throughout the drawings and description.

### DETAILED DESCRIPTION OF PREFERRED EMBODIMENTS

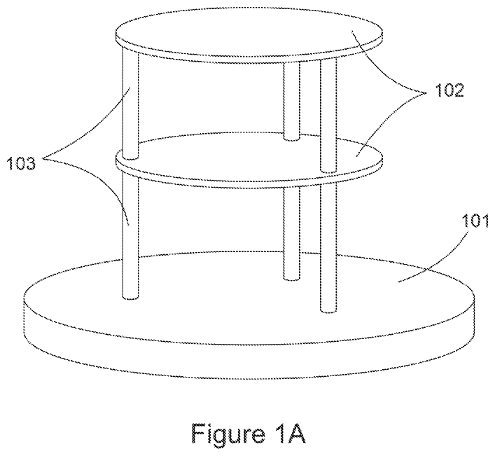

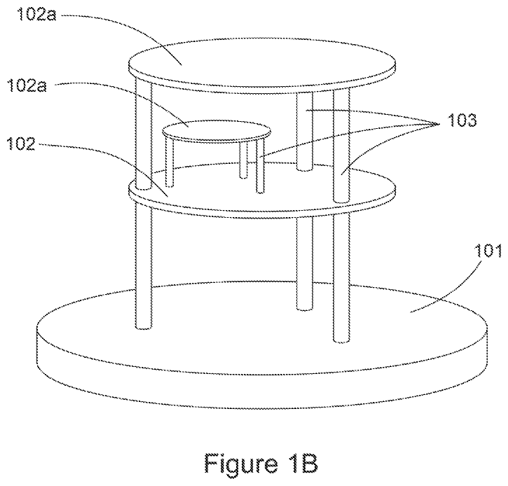

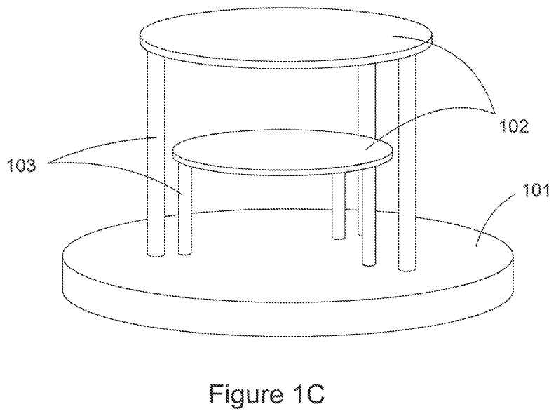

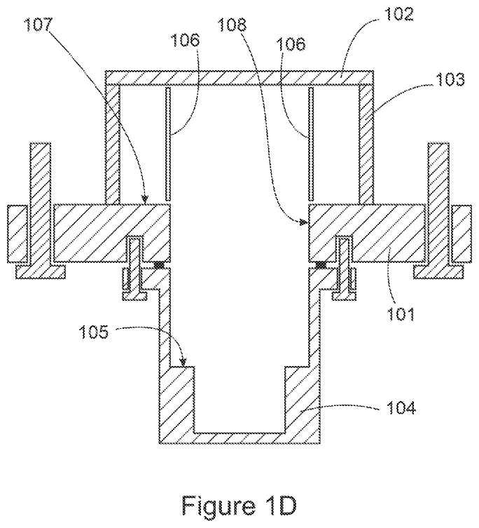

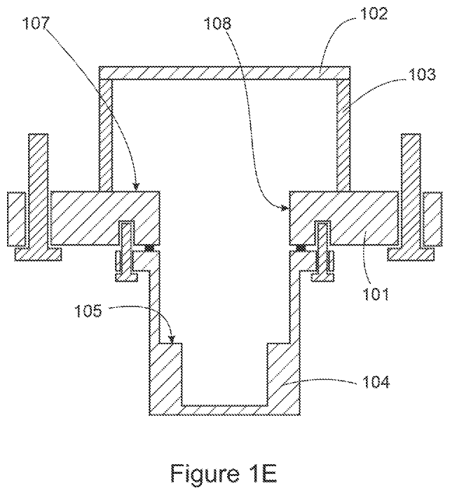

In the first aspect, referring to FIG. 1a, the invention provides the mechanical design of a time-of-flight mass spectrometer mounted on the vacuum side of a single vacuum flange 101. An advantage of this mechanical design approach is to enable the possibility to install the mass spectrometer directly into a process vacuum chamber (not shown in FIG. 1a) to monitor the process gases in-situ (dive-in instrument). However, the single-flange design allows also to install the same mass spectrometer into a small vacuum chamber (not shown in FIG. 1a) fitting to the instrument and therewith using the mass spectrometer as a standalone instrument.

A time-of-flight mass analyzer consists typically of multiple functional parts, such as for example an ion source, an extraction region, a drift region, a reflectron, and a detector. Typically, these functional parts form a longish elongated assembly. As all functional parts are mounted on the single flange 101 by means of one end of the longish assembly, a mechanical interface between the longish analyzer assembly and the single flange 101 must be strong enough to take up the torque of the longish assembly. As the installation and operation of the instrument shall be orientation independent and the instrument is exposed to e.g., vibrations, the mechanical structure must be stiff enough to take up all such forces applied substantially without twisting and guaranteeing mechanical alignment of all ion optical elements.

To fulfill these requirements the longish analyzer assembly is divided into several subassemblies, of which each subassembly forms a platform 102. These platforms 102 are stacked on top of each other onto the single flange 101 using at least one pillar 103 for distancing each platform 102 relative to the platform 102 below in direction of the single flange 101, or relative to the single flange 101.

In case a pillar 103 is fixed to the single vacuum flange 101, the pillar 103 may have a thread which is screwed into the single vacuum flange 101 (thread not shown in the FIGS. 1a-1d). On an end of the pillar 103 opposite to the side at the single vacuum flange 101 the platform 102, which may typically be a metallic body, is milled into shape that on one hand it can be slid over the pillars by a few millimeters for positioning and the platform 102 surfaces defines the angles of the platform 102. The platform 102 may be fixed either by one or more screws as appropriate (screws not illustrated in the FIGS. 1a-1d), if it is the most top one, or again one further pillar 103 or a set of pillars 103 depending on the case. A platform 102 may also be a printed circuit board PCB, which is used to mount parts on it. The material choice for the pillars 103 is driven on one hand by the allowed materials in an application, i.e., in order to reduce out-gassing in a vacuum environment, and on the other hand by mechanical issues like seizing of threads.

Referring now to FIG. 1c, which illustrates a preferred embodiment, each platform 102 is mounted onto its respective at least one pillar 103 directly mounted to the single flange 101 instead of stacking all of them on top of each other.

In a further preferred embodiment, and referring to FIG. 1b, which illustrates an example for this embodiment, e.g., at least two second level platforms 102a are mounted onto the platform 102, which operates as a first level platform. Beside the function of holding the individual subassemblies (not shown in FIG. 1b) in place, each of the second level platforms 102a and their first level platform 102 serve as mechanical reference for parts mounted on it (parts not illustrated in FIG. 1b), meaning that the platforms respectfully propagate their mechanical reference through the whole mechanical design. This allows to place the complex mechanical subassemblies of some ion optical elements precisely and allows to align them relatively to each other, even if they are mounted on different platforms.

Additionally, using the design approach with multiple platforms 102/102, 102a provides the advantage of being able to preassemble the subassemblies, which simplifies production. The disclosed mechanical design is not limited to stacking platforms 102 onto the inner surface of the vacuum flange 101.

As shown in FIG. 1d, an opening 108 operated into the single vacuum flange 101 opens the possibility to attach a small vacuum chamber 104 onto the single flange 101 and so obtain a “flange-on-flange design”, which allows forming further platforms 105 located at a level below the inner surface 107 of the single vacuum flange 101. «Small> is referring to the base area of the small vacuum chamber 104 being smaller than that of the single vacuum flange 101. The small vacuum chamber 104 is small enough to place it on the single vacuum flange 101, i.e., the main flange, in the required position, which is not necessarily centered. The space around the small vacuum chamber 104 may be used for placing feedthroughs (not shown in FIG. 1d). And there may also be feedthroughs on the small vacuum chamber 104 (not shown in FIG. 1d). Adding one or more platforms 105 at a level below the inner surface 107 of the single vacuum flange 101 and using them to mount mechanical parts on them, instead of mounting the mechanical parts directly on the small vacuum chamber's 104 floor, opens the possibility to have a small volume below the platform for integrating, e.g., electrical connections on feedthroughs, which allows to form a subassembly which can be assembled independently from the rest. Such a configuration may typically be used for installing the detector of the time-of-flight analyzer (detector and time-of-flight analyzer not shown in FIG. 1d). Preferably the detector may be an ion detector. This provides the inherent advantage to simplify the provision of an optional detector shield 106 to protect against charged particles present in the vacuum chamber. The detector shield 106 may be essential for extending the lifetime of the detector and to improve the signal-to-noise ratio of the detector signal due to reduced particle noise and results also in more reliable instrument operation. Especially for designing compact time-of-flight mass spectrometers such design details are key for high performance. Preferably, the detector shield 106 on the side is made from bent sheet metal, which is screwed to the single vacuum flange 101 and the platform 102 immediately above the single vacuum flange 101. In this configuration, the platform 102, which is the first platform to follow the single vacuum flange 101, acts also as a shield, except the cutouts which are required for opening a nominal ion flight path.

Additionally, installing the detector on the further platform 105 of the small vacuum chamber 104, which constitutes an individual part mounted on the single vacuum flange 101, provides the advantage of easy accessibility for exchange, as the detector is a consumable part of the instrument. In other words, the small vacuum chamber 104 can be removed and mounted again without changing the rest of the mechanical setup.

FIG. 1e illustrates a preferred embodiment of the device shown in FIG. 1d but without the optional detector shield 106.

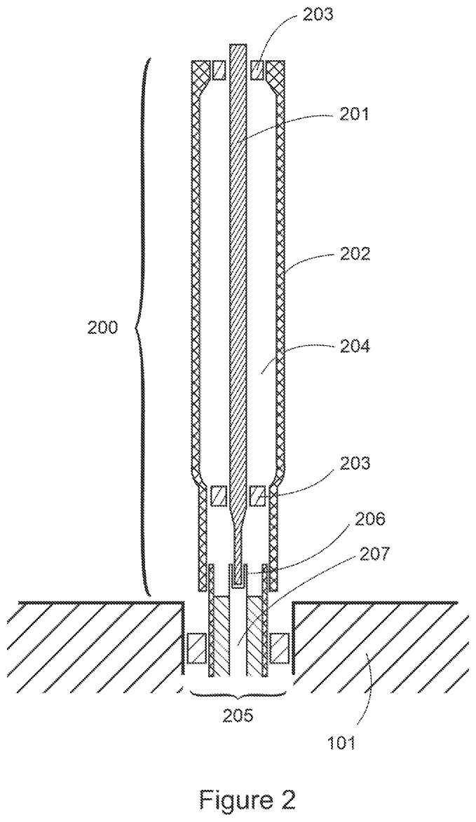

In a second aspect, the invention provides an impedance-matched coaxial conductor for vacuum environment 200, an example of which is illustrated in FIG. 2. The impedance-matched coaxial conductor 200 comprises an electrically conducting, e.g., metallic, inner conductor 201 and an outer hollow conductor 202 also made from an electrically conducting material. The two conductors 201 and 202 are separated, i.e., isolated from each other and positioned concentrically, i.e., substantially coaxially, to each other by at least one, typically two, elements which are electrically isolating 203. The electrically isolating elements 203 may for example be made from ceramics. An outer diameter of the inner conductor 201 and an inner diameter of the outer hollow conductor 202 are designed to match to an impedance-matched high frequency system, also taking the material properties of the dielectric materials, the latter comprising the electrically isolating elements 203 and a rest of space 204, e.g., vacuum, separating the inner 201 and outer 202 conductor into account. However, the isolating elements 203 holding the inner 201 and outer 202 conductor in place may be made from another material, i.e., a dielectric material, than the rest of the space 204 between the 201 inner and outer 202 conductor, due to fulfilling requirements, regarding for example low outgassing. The transition between the different dielectric materials forms an imperfection in the impedance-matched coaxial conductor 200. The shape and the number used of said isolators and their counter part on the electrically conducting parts are designed to reduce the imperfections to a minimum to achieve a conductor which performs substantially like a perfectly impedance-matched system. This is achieved by designing the appropriate dimensions of each segment with homogeneous dielectric material of the inner 201 and outer 202 conductor individually according to the formula for wave impedance Z_{L} of a coaxial conductor [2]

$${Z}_{L} = \frac{{Z}_{0}}{2 π \sqrt{{ϵ}_{r}}} ln ( \frac{D}{d} )$$

where Z₀ is the impedance of free space (vacuum), εᵣ the relative permittivity of the dielectric material between the inner 201 and outer 202 conductor, D the inner diameter of the outer conductor 202, and d the outer diameter of the inner conductor 201. The imperfection caused by the transition from one dielectric material to the other (e.g., from 203 to 204) is optimized by an (e.g., linear) interpolation of the mechanical dimensions of the coaxial conductor to minimize the imperfection and creating therewith a coaxial conductor performing substantially like a perfectly impedance-matched system.

In a preferred embodiment, the assembly of the impedance-matched coaxial conductor 200 may be mounted directly on a coaxial feedthrough 205, which guides the high-frequency signal from outside the vacuum environment into the vacuum environment, by screwing the outer hollow conductor 202 on a threaded terminal of the coaxial feedthrough 205 and clamping the inner conductor 201 onto a spring contact 206 of an inner terminal 207 of the coaxial feedthrough 205. The invention is not limited to mounting and contacting the outer hollow conductor 202 by a threaded interface and the inner conductor 201 by a spring contact. Other methods like for example clamping the outer conductor to the feedthrough are also possible. The coaxial feedthrough 205 may for example be operated in the single vacuum flange 101, for example by welding into the single vacuum flange 101.

The use of the impedance-matched coaxial conductor 200 is not limited to but especially useful in vacuum environments, i.e., harsh environment, in where the materials allowed to be used are highly restricted due to stringent requirements regarding for example low outgassing and/or chemical compatibility. Such requirements may limit the materials to be used to, e.g., stainless steel, aluminum, and gold for conducting elements and, e.g., ceramics (e.g., aluminum oxide) for isolating elements.

In a third aspect, the invention provides an electrically conducting contacting element 300 that enables a method for versatile and vacuum-proof electrical contacting.

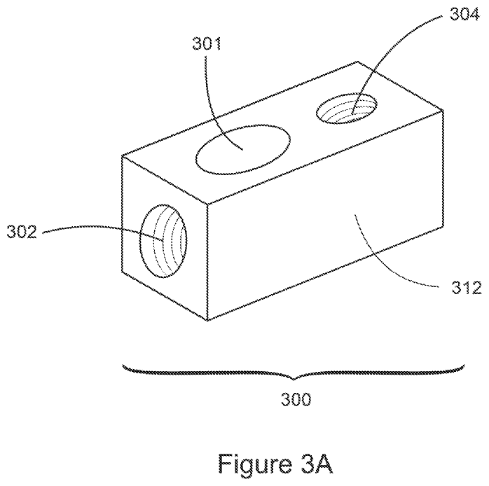

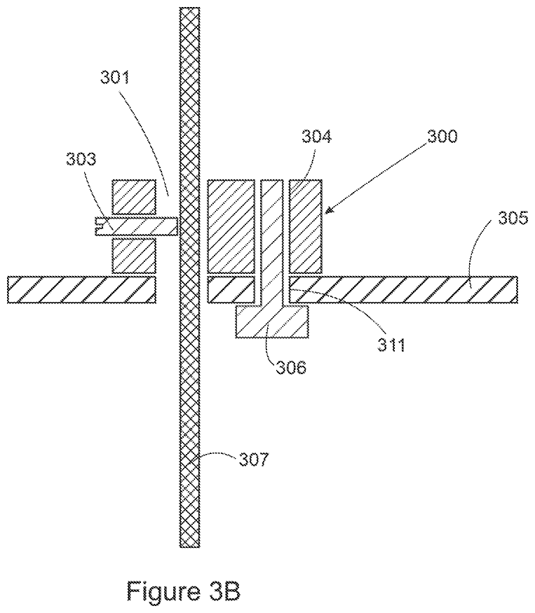

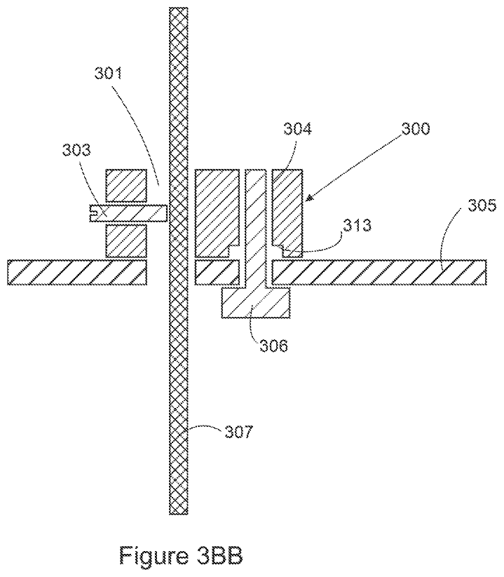

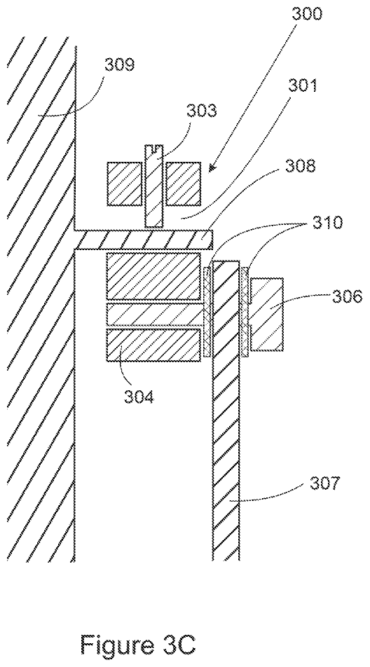

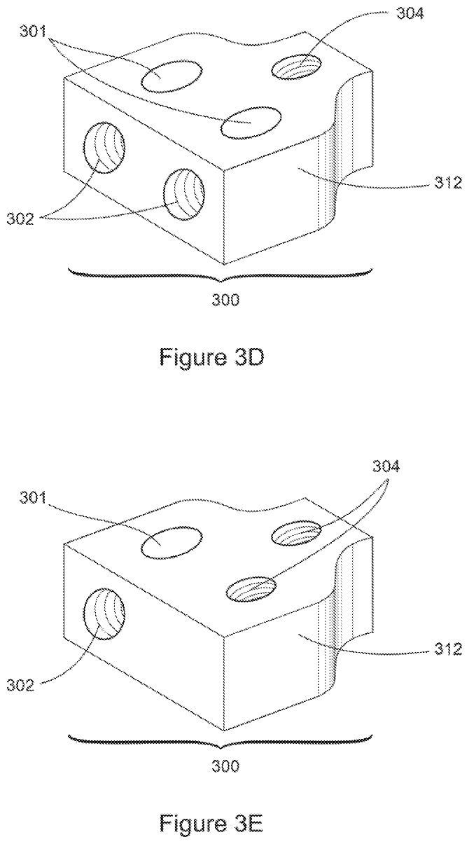

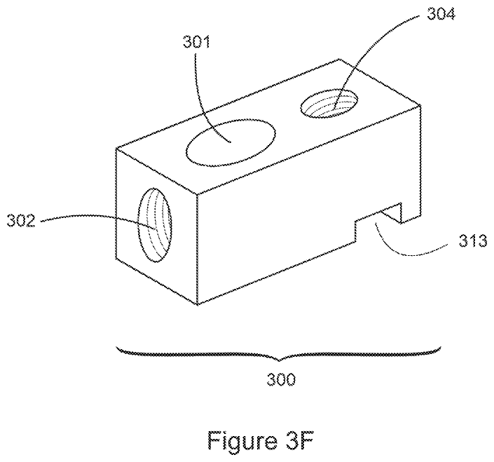

An example embodiment of the electrically conducting contacting element 300 is shown in FIG. 3a. The electrically conducting contacting element 300 may for example be made from metal. The electrically conducting contacting element 300, which establishes the electrical contact, comprises a body 312, which in preferred embodiments may be realized as a bracket, or an electrical terminal. The body 312 comprises at least one through hole 301 used to stick at least one conductor (conductor not illustrated in FIG. 3a) through the through hole 301 and an additional threaded hole 302 substantially 90 degrees orientated relative to the through hole 301 from an outside of the contacting element 300 to the through hole 301, and configured as shown in FIG. 3b for applying a screw 303 to clamp the conductor 307 into the electrically conducting contacting element 300.

At least one additional threaded hole 304 in the electrically conducting contacting element 300 is used to mount it on a mechanical body 305 by sticking an additional screw 306 through a fixing hole (or slit) 311 in the mechanical body 305 and fixing the electrically conducting contacting element 300 on the mechanical body 305 by tightening the additional screw 306. Typically, the mechanical body 305 is at least locally a conductor, e.g., the conducting part may be tracks of a printed circuit board (PCB) on the surface of the mechanical body 305.

The orientation of the through hole 301 and the additional threaded hole 304 is not limited to the parallel configuration as shown in FIG. 3a. The parallel configuration, e.g., allows to contact a conductor 307 perpendicular to a mechanical body, as shown in FIG. 3b. On the other hand, having the two holes 301 and 304 orientated substantially 90 degrees relative to each other allows to contact a conductor 307 substantially parallel to the mechanical body. Any other angles between the two holes 301 and 304 are also possible to mount conductors 307 in any orientation.

A preferred embodiment of the contacting element 300 is shown in FIG. 3f and FIG. 3bb: a channel 313 is added as a recess in the contacting element 300 at least around one extremity of the threaded hole 304 to support a venting of a volume encapsulated below the head of the screw 306 when mounted on a body 305.

The same concepts as illustrated in FIG. 3b and FIG. 3c (see herein below the description for FIG. 3c), used to connect the single conductor 307 to the mechanical body 305 or a further mechanical body 309 can also be used to contact two or more conductors 307 to the mechanical body 305 or the further mechanical body 309 by introducing multiple terminals in respective ones of multiple holes 301/302 or 304 into the body of a contacting element 312. FIG. 3d and FIG. 3e each show an example implementation of the electrically conducting contacting element 300 for contacting two conductors 307 according to the concept illustrated in FIG. 3b or FIG. 3c. The multiple terminal holes 301/302 in FIG. 3d or multiple holes 304 in FIG. 3e are not limited to be orientated in parallel as illustrated in the examples. It is also possible to have individual orientations of the terminal holes 301/302 or 304 to allow the contacting conductors 307 arriving from different directions. The electrically conducting contacting element 300 is not limited to but especially useful to establish electrical contacts in vacuum without using standard methods as for example soldering. The electrically conducting contacting element 300 is vacuum-proof and is compatible with very stringent requirements in some vacuum applications. This means that the contacting element 300, as well as the screws 303 and 306, are made from a low-outgassing material, as, e.g., stainless steel. In case the contacting element 300 and the screws 303 and 306 are made from the same material at least one of either the contacting element 300 or the screws 303 and 306 can be coated with, e.g., gold to avoid seizing of the screws. In addition, each thread and hole must be vented to achieve a vacuum-proof design, which is fulfilled by the contacting element 300, as all holes 301, 302, and 304 are made as through holes, and a channel 313, operated as a recess in the contacting element at around the circumference of threaded hole 304 at least on a side of the threaded hole 304 in contact with the body 305, supports the venting of the volume below the head of the screw 306. A typical application for the described electrical terminal is to contact wires to a (ceramic) printed circuit board (PCB) in vacuum.

Referring now to FIG. 3c, the described electrically conducting contacting element 300 may also be used vice versa as described above, by sliding the through hole 301 onto a pin 308 of a further mechanical body 309 and using the substantially 90 degrees orientated screw 303 to fix the electrically conducting contacting element 300 on the further mechanical body 309. The electrical conductor 307 is then contacted on the other end of the element 300 to the threaded hole 304 by for example clamping the electrical conductor 307 under a screw head of the additional screw 306 to the element 300. The reliability of this connection may be improved by using at least one washer 310 to clamp the electrical conductor 307 or preferred clamping the electrical conductor 307 between two washers 310.

### REFERENCES

[1] UPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8. https://doi.org/10.1351/goldbook.
[2] A. Küchler. Hochspannungstechnik. Springer-Verlag Berlin Heidelberg, 2. Auflage, 2005. ISBN 978-3-540-78413-5. https://doi.org/10.1007/978-3-540-78413-5.

1-8. (canceled)

9. A time-of-flight mass analyzer comprising:
a plurality of functional parts selected from at least the following list: an ion source, an extraction region, a drift region, a reflectron, and a detector;
a single vacuum flange configured to connect on a vacuum chamber;
a plurality of platforms;
at least one pillar for each of the plurality of platforms, configured for fixing and distancing the corresponding platform either to the single vacuum flange or to a neighboring platform from the plurality of platforms;
each of the plurality of platforms being configured to gather a subset of the plurality of functional parts to obtain a subassembly; and
the subassemblies and the single vacuum flange being arranged to form a longish elongated assembly in which each of the platforms defines a mechanical reference in the longish elongated assembly.

10. The time-of-flight mass analyzer of claim 9, wherein the platforms are stacked on top of each other onto the single vacuum flange.

11. The time-of-flight mass analyzer of claim 9, further comprising at least an additional platform, and at least one additional pillar for each of the additional platforms, whereby each of the additional platforms is mounted directly on the single vacuum flange by means of the one of plurality of corresponding additional pillars.

12. The time-of-flight mass analyzer of claim 11, wherein at least one of the plurality of platforms and the additional platforms is defined as a first level platform, the time-of-flight mass analyzer further comprising:
for each first level platform at least one second level platform mounted on the first level platform by means of at least a corresponding second level pillar.

13. The time-of-flight mass analyzer of claim 9, wherein the single vacuum flange comprises an opening, the time-of-flight mass analyzer further comprising:
an annex vacuum chamber mounted on the opening of the single vacuum flange; and
at least a further annex platform located inside the annex vacuum chamber.

14. The time-of-flight mass analyzer of claim 13, further comprising:
a particle shield located on the single vacuum flange on a side oriented toward the at least one platform and configured to protect an inside of the annex vacuum chamber from charged particles.

15. The time-of-flight mass analyzer of claim 9, further comprising:
at least a screw system configured to fix at least one of the plurality of platforms to the corresponding at least one pillar.

16. An impedance-matched coaxial conductor for a vacuum environment, the impedance matched coaxial conductor comprising:
an electrically conducting inner conductor;
an electrically conducting outer hollow conductor configured to surround the inner conductor substantially along its entire length, whereby the outer hollow conductor is separated from the inner conductor;
at least an electrically isolating element positioned between the inner conductor and the outer hollow conductor in order to maintain the separation between them; and
a space between the inner conductor and the outer hollow conductor being vacuum pumpable.

17. The impedance-matched coaxial conductor of claim 16, wherein the outer hollow conductor comprises on one extremity of the impedance-matched coaxial conductor a means for connecting to a coaxial feedthrough of a wall of a vacuum chamber.

18. The impedance-matched coaxial conductor of claim 17, wherein the outer hollow conductor comprises on the one extremity an internal cylindrical surface and a screwable thread on the internal surface, configured to screw in the coaxial feedthrough.

19. An electrically conducting contacting element for a vacuum environment, which is configured to establish an electrical contact between a first conductor and a second conductor, the electrically conducting contacting element comprising:
a body made from an electrically conducting material;
at least a through hole in the body, configured to accept inside the hole the first conductor in form of an elongated electrical conductor;
at least a first threaded hole in the body, oriented substantially perpendicular to the through hole, and extending from an outside surface of the body to the through hole, the threaded hole being configured to accept a screw; and
at least a second threaded hole in the body.

20. The electrically conducting contacting element for a vacuum environment of claim 19, in which the electrical conducting material is made from stainless steel.

21. A method for vacuum-proof electrical contacting, the method comprising:
providing an electrically conducting contacting element for a vacuum environment, which is configured to establish an electrical contact between a first conductor and a second conductor, the electrically conducting contacting element comprising:
a body made from an electrically conducting material,
at least a through hole in the body, configured to accept inside the hole the first conductor in form of an elongated electrical conductor,
at least a first threaded hole in the body, oriented substantially perpendicular to the through hole, and extending from an outside surface of the body to the through hole, the threaded hole being configured to accept a first screw, and
at least a second threaded hole in the body;
clamping, by using the first screw screwed inside the first the led hole and protruding in the through hole, the first conductor inside the through hole; and
mounting, by using a second screw screwed in the second threaded hole, the electrically conducting contacting element on the second conductor.

22. The method of claim 21, further comprising:
providing the second conductor as a track on a surface of a printed circuit board; and
passing the second screw through an aperture in the printed circuit board before screwing it in the second threaded hole.

23. The method of claim 21, further comprising:
providing the second conductor as a further elongated electrical conductor; and
clamping, by using the second screw screwed into the second threaded hole, the further elongated electrical conductor onto the electrically conducting contacting element.
